(19) United States
(12) Patent Application Publication
(10) Pub. No.: US 2024/0302053 A1
(43) Pub. Date: Sep. 12, 2024

(54) Method for securing an induction cooking device under a worktop

(71) Applicant: NOVY, Kuurne (BE)

(72) Inventors: Lucas GRUWEZ, Heule (BE); Randy FEYS, Zingem (BE); Dries SABBE, St Amandsberg (BE); Henk HUISSEUNE, Melle (BE)

(21) Appl. No.: 18/598,285

(22) Filed: Mar. 7, 2024

(30) Foreign Application Priority Data
Mar. 8, 2023 (BE) BE2023/5171

(51) Int. Cl. F24C 15/10; H05B 6/12

(52) U.S. Cl. CPC F24C 15/108; H05B 6/1209

(57) ABSTRACT

A method for securing an induction cooking device (5) under a worktop (2) having an upper surface, a lower surface and at least one opening extending through the worktop. The method comprises: providing a support frame comprising two mutually parallel rails connected via a transverse element; providing the induction cooking device, which induction cooking device comprises a tower-shaped element projecting from the upper surface; placing a temporary securing means in the opening in the worktop; securing the transverse element to the temporary securing means; fixing the parallel rails relative to the worktop; removing the transverse element and the temporary securing means; placing the induction cooking device under the worktop with the tower-shaped element in the opening; and fixing the induction cooking device to the parallel rails. This method can be performed by one person and results in accurate positioning of the induction cooker relative to the worktop.

### TECHNICAL FIELD

The present invention relates to a method for securing an induction cooking device under a worktop.

### PRIOR ART

Induction cooking devices are known and usually comprise a frame carrying an induction coil that serves as an inductor. A generator is provided to apply an alternating current to the induction coil and a magnetic flux concentrator, typically made of ferrite, is provided under the induction coil. A cooking worktop in the form of a glass ceramic plate is typically provided on top of the induction cooking device. This glass ceramic plate is then inserted into an opening of a traditional worktop (for example made of natural stone, such as granite or marble, laminate materials, composite materials, etc.). The alternating current in the induction coil generates a magnetic field that generates eddy currents in the underside of an electrically conductive holder (i.e. a cooking pot; of course, a cooking pot is also meant to include pans and other common cooking holders) placed on top of the cooking worktop. The distance between the top surface of the induction coil and the cooking surface (i.e. the top surface of the glass ceramic plate) is usually about 4 mm to 6 mm.

Several disclosures have already been made regarding so-called invisible induction cooking devices. More specifically, in these disclosures, the worktop is continuous and no opening is provided for the glass ceramic cooking worktop. Examples can be found in WO 97/30567 A1, WO 98/41064 A2, U.S. Pat. No. 6,080,975 A, WO 2014/108521 A1 and EP 3032917 A1. A common problem for invisible induction cooking devices is the efficiency of energy transfer from the induction coil to the cooking pot placed on the cooking surface. More specifically, in invisible induction cooking devices, the distance between the induction coil and the cooking surface can be in the order of 6 to 50 mm, depending on the worktop design, which distance is greater compared to conventional induction cooking devices with a glass ceramic top plate. Increasing this distance has a negative impact on the efficiency of energy transfer.

To alleviate this problem, known invisible induction cooking devices rely on providing one or more recesses in the lower surface, and the induction cooking devices are then placed in these recesses. The recesses make it possible to reduce the distance between the cooking surface and the induction coil in the induction cooking device in order to improve energy transfer from the induction coil to the cooking pot placed on the cooking surface. An alternative solution is to rely on very thin work plates (e.g. work plates with a thickness of 6 or 8 mm). However, this requires an additional support frame under the work plate to provide the required strength for the work plate.

A drawback of known invisible induction cooking devices is that the recesses structurally weaken the worktop and/or require an additional support frame that is undesirable. Moreover, this also limits the size of and/or the number of induction cooking devices that can be provided in the cooking assembly.

Another drawback of known invisible induction cooking devices is that the heat generated in the cooking pot can negatively impact the worktop, causing a crack in the worktop, for example. A known solution to this problem is to provide a thermal insulation layer between the worktop and the cooking pot, which layer also prevents direct contact. Examples are disclosed in WO 2012/98262 A1, ES 2455442 A1, WO 2019/130180 A1 and WO 2020/34011 A1. However, the use of additional layers is cumbersome and increases the overall cost of the induction cooking device.

Another solution is to use feet under the cooking pot to have an air gap between the work plate and the cooking pot, thus creating a thermal insulation layer. However, this requires application-specific cooking pots for the invisible induction cooking device, which is undesirable.

Yet another solution for avoiding damage to the worktop is to limit the induction power, e.g. to a maximum power equal to 3000 W, or to only allow high induction powers for a limited time (e.g. 3700 W for only a few seconds). However, this also limits the maximum cooking temperatures obtained, which then remain characteristically below 200° C., which temperatures are not sufficient to cook certain specific dishes.

In the context of such problem definition, an improved induction cooking device was disclosed in WO 2022/101462 A1 that can be placed under a worktop without structurally weakening the worktop.

### DISCLOSURE OF THE INVENTION

It is an object of the present invention to provide a method for securing an induction cooking device, in particular an induction cooking device disclosed in WO 2022/101462 A1, under a worktop.

This objective is achieved according to the invention by providing a method for securing an induction cooking device under a worktop, which worktop has an upper surface and a lower surface facing each other and comprises at least one opening extending through the worktop between the upper surface and the lower surface, the method comprising: providing a support frame comprising two mutually parallel rails connected via a transverse element; providing the induction cooking device having an upper surface and a lower surface, wherein the upper surface of the induction cooking device is substantially flat and configured to be placed on the lower surface of the worktop and substantially parallel to the lower surface, which induction cooking device comprises a tower-shaped element projecting from the upper surface; placing a temporary securing means in the opening in the worktop; securing the transverse element to the temporary securing means for the purpose of securing the support frame to the lower surface of the worktop; fixing said parallel rails relative to the worktop; removing the transverse element and the temporary securing means; placing the induction cooking device under the worktop with the tower-shaped element in the opening; and fixing the induction cooking device to said parallel rails.

This method of working has the following main advantages. The placement of the induction cooking device relative to the worktop and in particular to the opening therethrough is accurate and correct. This is due, inter alia, to the use of mutually parallel rails that are accurately placed relative to the opening through the worktop by means of the temporary securing means and the transverse element (which is also intended for temporary use only). The transverse element sits through the temporary securing means in a desirable position relative to the opening in the worktop. By replacing the transverse element with the induction module, the latter is therefore also positioned as required, i.e. with the tower-shaped element through the opening.

Moreover, the entire method can be carried out by one person. Typically, the induction cooking device is a rather heavy element to assemble. There is therefore often a need for two people for installation, namely one person to place the induction cooking device correctly on the lower surface of the worktop so that the other person can carry out the fixing. However, by using the temporary securing means and the transverse element, the support frame can be temporarily held on the lower surface of the worktop without the need for one person to continue holding it. Hence, one person on their own can first position this support frame, after which it is temporarily held by the temporary securing means and the transverse element so that the same person can carry out the fixing. Then the same can be done for the induction cooking device, which can first be placed on the support frame and is thereby supported, after which the fixing can be carried out.

In an embodiment of the present invention, placing the induction cooking device under the worktop comprises placing the induction cooking device against the lower surface of the worktop. However, it is alternatively possible to provide a certain minimum distance between the induction cooking device and the lower surface of the worktop.

In an embodiment of the present invention, the method further comprises successively placing multiple induction cooking devices under said worktop. This provides a high degree of modularity and flexibility since multiple cooking zones can be provided. Preferably, each induction cooking device is placed on one common support frame. This avoids the need for multiple separate support frames, which would increase the total cost as well as the time needed for placement.

In an embodiment of the present invention, the worktop is supported by at least two walls (typically side walls of a cabinet space below the worktop) facing each other, wherein fixing said parallel rails relative to the worktop comprises: fixing the ends of each rail to one of said walls. This avoids the need to secure the parallel rails directly to the lower surface of the worktop. Indeed, such direct securing would introduce local weakening into the worktop, e.g. due to the cavities necessary to receive bolts or screws (general securing means). Wall fixing avoids such local weakening and is therefore advantageous.

In a preferred embodiment of the present invention, each rail of said rails is provided near its ends with an L-shaped securing member, wherein a first leg of each L-shaped securing member is slidably mounted on a corresponding rail, and wherein fixing the ends of each rail to one of said walls comprises: sliding an L-shaped securing member along a corresponding rail until it rests against a corresponding wall; and fixing a second leg of the L-shaped securing member against the corresponding wall by means of securing means such as bolts or screws. Preferably, the method further comprises: shortening each rail depending on the shortest distance between said walls by preferably removing substantially equal amounts of material at each end.

The use of sliding L-shaped securing members avoids the need to make the rails exactly to size given the distance between the side walls. This mutual distance is often selected from a number of standard dimensions, e.g. 60 cm, 65 cm, 70 cm, 75 cm, 80 cm, 85 cm, 90 cm, 95 cm, 100 cm, 105 cm, 110 cm, 115 cm, 120 cm, 125 cm, 130 cm or other dimensions. However, in practice there are often slight differences from the standard dimensions. L-shaped securing members can compensate for these differences without the need to cut the rails to size. To further reduce the number of rails needed, one or two standard dimensions of rails are preferred, e.g. 75 cm or 80 cm on the one hand and 120 cm or 125 cm on the other. The standard dimension rails of 75/80 cm are in this case used for side wall dimensions of, for example, 60 cm, 65 cm, 70 cm, 75 cm, while the standard dimension rails of 120/125 cm are used for side wall dimensions of, for example, 75 cm, 80 cm, 85 cm, 90 cm, 95 cm, 100 cm, 105 cm, 110 cm, 115 cm, 120 cm. In other words, the rails are often longer than the available distance between the side walls. As a result, the method comprises a step of shortening the rails, preferably by removing material from both ends. The sliding L-shaped securing members in this case also mean that it is not necessary to shorten too precisely (e.g. a difference of a few millimetres or centimetres) as differences can be accommodated by sliding the L-shaped securing members.

In an embodiment of the present invention, each of said rails is provided with a magnetic element (e.g. a ferromagnet such as an iron element), wherein the induction cooking device is provided with a magnetic element (e.g. a permanent magnet) on opposite sides, and wherein fixing the induction cooking device to said parallel rails comprises: temporarily securing the induction cooking device to said rails by means of magnetic attraction between the magnetic elements in said rails and the induction cooking device. Preferably, fixing the induction cooking device to said parallel rails comprises: fastening the induction cooking device to said rails by securing means such as bolts or screws.

As used herein, the term “magnetic element” is intended to refer, on the one hand, to a magnet (e.g. a permanent magnet or an electromagnet) as well as to an element attracted to a magnet (e.g. a ferromagnet or ferrimagnet).

Using magnets as temporary securing means is first of all reliable in the sense that they will not normally detach accidentally. It also ensures reliably correct placement. This placement is preferably such that the tower-shaped element matches the opening in the worktop where the temporary securing means were previously located. There is also no need for additional elements (such as glue, adhesive tape, screws, bolts, etc.). In addition, there is no need to provide hooks, openings, gripping points, etc. that could locally weaken the rails and/or the induction cooking device and/or require additional production steps. An additional fastening ensures that the induction cooking device remains correctly secured relative to the worktop during years of use and/or in the event of unexpected extreme stresses (e.g. an earthquake, a heavy object falling onto the worktop, impact against the induction cooking device from the cabinet space under the worktop, etc.), where the magnetic connection may be less reliable.

In an embodiment of the present invention, each rail comprises a first placement means and the induction cooking device comprises corresponding second placement means. Together, these placement means contribute to the correct placement (i.e. positioning) of the induction cooking device relative to the rails. Since in the method according to the present invention the rails (via the transverse element and the temporary securing means) have the desired placement relative to the opening in the worktop, the first placement means are thus desirably placed relative to the opening in the worktop. Combined, the first and second placement means thus provide the desired correct placement of the induction cooking device relative to the opening in the worktop.

The magnetic elements for temporarily securing the induction cooking device to the rails described above can also serve as first and second placement means. Hence, these can have a dual function so that the number of elements can be limited.

In an embodiment of the present invention, the temporary securing means comprises a magnetic element, wherein the transverse element comprises a magnetic element and wherein securing the transverse element to the temporary securing means comprises: temporarily securing the support frame to the temporary securing means by means of magnetic attraction between the magnetic elements.

Using magnets as temporary securing means is first of all reliable in the sense that they will not normally detach accidentally. It also ensures reliably correct placement. There is also no need for additional elements (such as glue, adhesive tape, screws, bolts, etc.). In addition, there is no need to provide hooks, openings, gripping points, etc. that require additional production steps.

In an embodiment of the present invention, providing the induction cooking device comprises: providing the induction cooking device with a tower-shaped element extending between a proximal end near the upper surface of the induction cooking device and a distal end, wherein a temperature sensor is provided near the distal end, which temperature sensor is connected to the induction cooking device via a cable; and providing a shield cover. Preferably, the shield cover comprises a flanged edge. Preferably, the shield cover is made of metal, such as stainless steel.

A temperature measuring system (such as a temperature sensor) is advantageous as it allows monitoring of the cooking pot temperature. In this way, legally imposed safety conditions can be monitored. Moreover, this also makes it possible to monitor the heating of the worktop to prevent damage to the worktop (e.g. a crack or tear). More specifically, the temperature sensor monitors the cooking pot temperature, which is used as an indirect measure of the local worktop temperature.

The flanged edge on the upper surface of the shield cover prevents the shield cover from being pushed too deeply into the opening in the worktop. This is because pushing it too deep can result in too great a distance from the cooking pot, which can make the temperature measurement unrepresentative. The same can possibly also be achieved with another type of securing (e.g. glue) but this then typically requires an additional mounting step. This flanged edge is rather thin (e.g. a thickness of 0.05 mm; 0.1 mm; 0.15 mm; or 0.2 mm) so that the cooking pots have less tendency to wobble (or ideally do not wobble) due to the projecting flanged edge relative to the upper surface of the worktop. A metal shield cover is advantageous in terms of thermal conductivity. Stainless steel has the further advantage of low electrical conductivity so there is less heating due to the magnetic field generated by the induction cooking device. Such heating can also lead to an unrepresentative temperature measurement.

In a preferred embodiment of the present invention, after fixing the induction cooking device to said parallel rails, the method further comprises: detaching the temperature sensor from the tower-shaped element so that said temperature sensor is accessible on the upper surface of the worktop; removing the tower-shaped element; fixing the shield cover to the temperature sensor; and fixing the shield cover in the opening, for example, by gluing it therein.

In this embodiment, the tower-shaped element serves as a temporary holder for the temperature sensor. The latter is thus temporarily fixed during placement of the induction cooking device and therefore cannot snag on an external element or get stuck and/or damaged.

Furthermore, the temperature sensor is placed directly under the shield cover, which in the final product can make contact with the cooking pot or is at least close to it (cooking pots sometimes have a hollow or non-planar bottom, which means that direct contact is not always possible). In this way, the temperature sensor can be mounted close to (e.g. immediately under) the cooking pot to accurately monitor the cooking temperature. Moreover, temperature detection and temperature control is much faster and much more accurate compared to using a conventional glass ceramic plate because the opening through the worktop allows direct contact (“direct contact” refers to the direct thermal contact between the temperature sensor and the cooking pot notwithstanding the presence of the shield cover and possibly the minute air gap due to a non-planar cooking pot base between them) between the temperature sensor and the cooking pot. The shield cover is preferably also thin-walled to minimise the impact (in particular the latency that may occur due to the time required for heat dissipation through the shield cover) on the temperature measurement, e.g. with a thickness between 0.2 mm and 2 mm, preferably between 0.5 mm and 1.5 mm, more preferably between 0.7 mm and 1.3 mm and most preferably between 0.9 mm and 1.1 mm. In addition, the shield cover also serves as additional protection for the temperature sensor.

In an embodiment of the present invention, placing a temporary securing means in the opening in the worktop comprises: clamping the worktop between two separate elements which together form the temporary securing means. Preferably, clamping the worktop between two separate elements comprises: placing a first element of the temporary securing means on the lower surface of the worktop; and screwing thereon a second element of the temporary securing means to the upper surface of the worktop.

The use of a clamping effect between the temporary securing means and the worktop ensures secure positioning of the temporary securing means relative to the opening in the worktop. This therefore contributes to the desired positioning of the rails and the induction cooking device relative to the worktop. To achieve a clamping effect, the temporary securing means should consist of at least two elements secured together. As the upper surface of the worktop is typically more easily accessible than the lower surface thereof, it is desirable to screw the upper element into the lower one and not vice versa.

In an embodiment of the present invention, the worktop comprises N openings extending through the worktop between the upper surface and the lower surface, wherein N is a natural number greater than one, wherein the induction cooking device comprises N tower-shaped elements projecting from the upper surface and wherein the method comprises: placing a temporary securing means in at least two of the N openings in the worktop; securing the transverse element (to which the rails are secured) to at least two temporary securing means or securing two (or more) transverse elements to one temporary securing means each; fixing the rails relative to the worktop, in particular by securing them to the side walls of the cabinet; removing the transverse elements and the temporary securing means; and placing the induction cooking device under the worktop with each tower-shaped element in a corresponding opening. The main reason for this embodiment is to place an induction cooking device having multiple induction coils wherein each tower-shaped element corresponds to an induction coil.

In an embodiment of the present invention, providing the induction cooking device comprises: providing an induction cooking device comprising: a frame; an induction coil supported by the frame and having a bottom and a top, wherein the top is oriented towards the worktop, wherein the induction coil is formed of a wire having a substantially uniform non-circular cross-section having a width and a height, wherein the height is greater than the width; a generator connected to the induction coil and configured to supply an alternating current to the induction coil, wherein the alternating current has a frequency between 25 KHZ and 100 KHZ; and a magnetic flux concentrator placed between the frame and the bottom of the induction coil, wherein the magnetic flux concentrator covers at least 50% of the bottom of the induction coil and has a relative magnetic permeability of at least 1000.

As described in WO 2022/101462 A1, an induction cooking device having (compared to known induction cooking devices) coil windings that are closer together (due to their non-circular cross-section), which maximises their mutual induction, an increased frequency of the alternating current and an increased reluctance of the magnetic flux concentrator results in a generated magnetic field capable of transferring energy to locations further away from the induction coil. In particular, such an induction cooking device is capable of effectively transferring sufficient energy to heat a cooking pot located 20 mm or more from the induction coil.

It should be clear that the induction cooking device can also comprise multiple separate induction coils to create multiple cooking zones. Typically, an induction cooking device will comprise one or two induction coils. A conventional cooking solution with 4 cooking zones can therefore be obtained by placing two induction cooking devices side by side, with each induction cooking device being provided with two induction coils. A different number of cooking zones (e.g. 2, 5, 6, etc.) is of course also achievable.

In an embodiment of the present invention, the method further comprises providing the worktop. This preferably comprises providing a worktop having a substantially constant thickness, which thickness is at least 6 mm, in particular at least 12 mm, more specifically at least 16 mm, and even more specifically at least 18 mm, which thickness is at most 50 mm, in particular at most 40 mm, more specifically at most 30 mm, even more specifically at most 25 mm, and most specifically at most 22 mm, which thickness is most advantageously substantially 20 mm.

An induction cooking device as described in WO 2022/101462 A1 is optimal for use in an arrangement where the distance between the top of the induction coil and the top surface of the worktop is ideally between 18 and 22 mm. With a greater distance, the coupling between the induction coil and the cooking pot is lower, causing the cooking pot to heat more slowly. Moreover, this can also cause problems with high currents in the generator if it is based on a resonant inverter. With a smaller distance, the overall coupling between the induction coil and the cooking pot is higher, which can lead to the cooking pot heating too fast, and to unsafe situations (e.g. a cooking pot that can become hotter than legally permitted).

A worktop of uniform thickness is further advantageous because the overall structural integrity of the cooking worktop is in this case also uniform.

The worktop is typically made of a heat-resistant material, such as porcelain, ceramic, glass, or a sintered material. It was found that such materials are able to withstand the heat conduction of the cooking pot without being damaged.

It should be clear that, as will also become apparent from the further description below, the different embodiments identified above (including any optional features indicated) are not separate elements, but, on the contrary, that these different elements can be combined with each other to obtain yet other embodiments than those already described, which embodiments are also part of the present invention.

### BRIEF DESCRIPTION OF THE DRAWINGS

The invention is further explained by the following description and the accompanying figures.

FIG. 1 shows a perspective view of a cabinet space having on it a worktop with an induction cooking device secured underneath.

FIG. 2 shows a bottom view of FIG. 1 with the doors of the cabinet space removed.

FIGS. 3 to 18F show the sequential steps of the method of securing an induction cooking device in the cabinet space under the worktop, wherein:

FIG. 3 shows the empty cabinet space;

FIG. 4A shows the placement of the temporary securing means in the worktop;

FIG. 4B shows a detail of FIG. 4A;

FIG. 5A shows the worktop with the temporary securing means secured in a top view;

FIG. 5B shows the worktop with the secured temporary securing means in a bottom view;

FIG. 6A shows a top view of the support frame;

FIG. 6B shows a bottom view of the support frame;

FIG. 7 shows the placement of the support frame on the temporary securing means in the worktop;

FIG. 8 shows the worktop with the support frame secured thereto;

FIG. 9 shows the sliding of the L-shaped securing members;

FIG. 10 shows the fixing of the L-shaped securing members to the cabinet space;

FIG. 11 shows the removal of the transverse element;

FIG. 12A shows the removal of the temporary securing means;

FIG. 12B shows a detail of FIG. 12A;

FIG. 13 shows the secured rails under the worktop;

FIG. 14 shows the placement of the induction cooking device under the worktop;

FIG. 15 shows the fixing of the induction cooking device to the rails;

FIG. 16 shows a top view of the worktop with the tower-shaped element projecting therefrom;

FIGS. 17A to 17G show the removal of the tower-shaped element; and

FIGS. 18A to 18F show the completion and placement of the temperature sensor in the worktop.

### DESCRIPTION OF THE INVENTION

The present invention is described with respect to specific embodiments and with reference to certain drawings, although the invention is not limited thereto, but only by the claims. The drawings described are purely schematic and are non-limiting. In the drawings, the size of some of the elements may be exaggerated and not drawn to scale for illustrative purposes. The dimensions and relative dimensions do not necessarily correspond to actual reductions for the practice of the invention.

Furthermore, the terms “first”, “second”, “third” and the like are used in the description and in the claims to distinguish between similar elements and not necessarily to describe a sequential or chronological order. The terms are interchangeable under appropriate circumstances and the embodiments of the invention may operate in different sequences than those described or illustrated herein.

In addition, the terms “top”, “bottom”, “upper”, “lower” and the like are used in the description and claims for descriptive purposes. The terms thus used are interchangeable under appropriate circumstances and the embodiments of the invention described herein may operate in orientations other than those described or illustrated herein.

Further, the various embodiments, although described as “preferable”, should be interpreted as characterising ways in which the invention may be implemented rather than as limiting the scope of the invention.

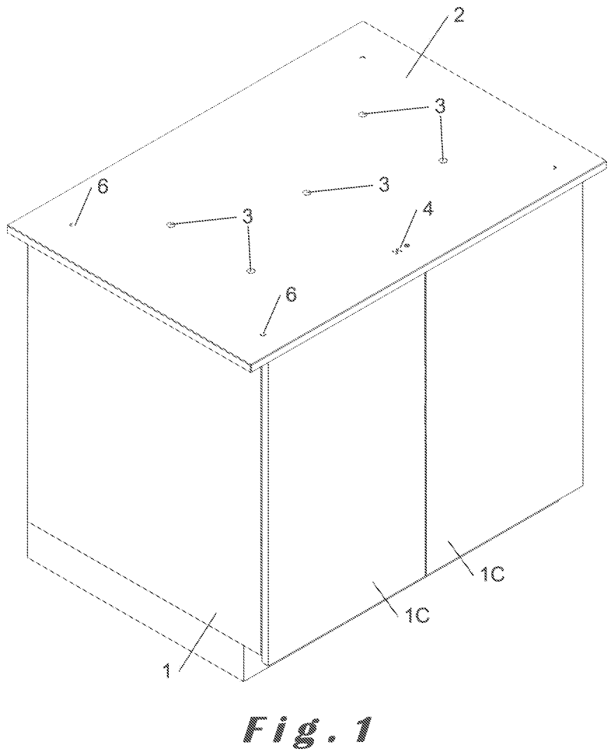

FIG. 1 shows a perspective view of a cabinet space 1 containing a worktop 2, which worktop 2 is provided with multiple (five in the embodiment shown) openings 3. The worktop 2 is made of a heat-resistant material, such as porcelain, ceramic, glass, or a sintered material. The worktop 2 has a substantially constant thickness, which may be in the range of 9 to 50 mm and is preferably about 20 mm.

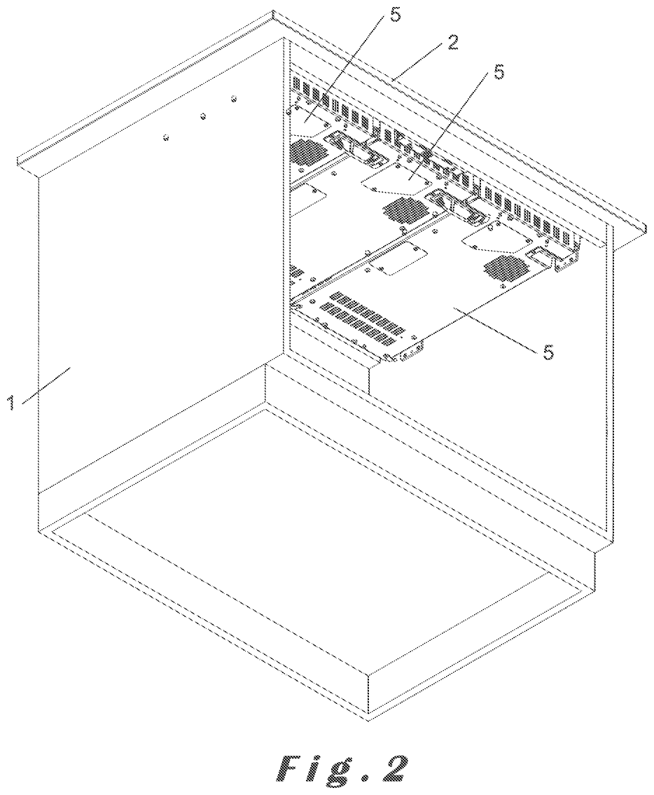

In the cabinet space, as shown in FIG. 2, one or more (three in the embodiment shown) induction cooking devices 5 are secured under the worktop 2 by a method according to the present invention. The induction cooking devices 5 used are preferably those as disclosed in WO 2022/101462 A1, which are specifically designed for use under a worktop.

FIGS. 1 and 2 therefore show a worktop 2 having induction cooking devices 5 which together thus provide five cooking zones, i.e. one cooking zone per through-opening 3. The through-openings 3 provide an easy way for the end user to identify cooking zones. In the design shown, markings 6 are further provided to identify the cooking zone, which is advantageous as the worktop 2 typically runs continuously to the rest of the kitchen. A controller 4 for the induction cooking devices 5 is also shown in the worktop 2. Details regarding a controller for induction cooking devices 5 are assumed to be known by the person skilled in the art.

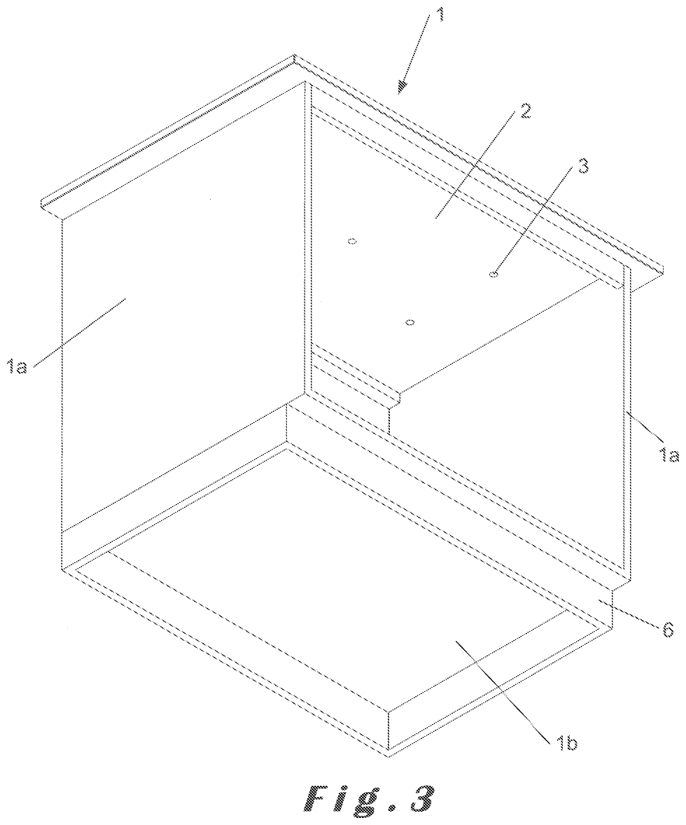

FIG. 3 shows the kitchen cabinet 1 with its doors removed and, on top, the worktop 2, in which the through-openings 3 are fitted. In practice, the kitchen cabinet 1 is installed as part of a kitchen and the induction cooking device 5 should be put in place at a follow-up stage. The kitchen cabinet 1 comprises two vertical walls 1a, a bottom 1b, doors 1c (either sliding or a fixed wall) and a top wall formed by the worktop 2. Furthermore, the Figures also show the presence of skirting boards 6 at the bottom 1b of the kitchen cabinet 1. In the scope of the present invention, it is mainly relevant that the worktop 2 is supported by two side walls 1a facing each other. The distance between the side walls 1a can be customised according to the kitchen, but is typically selected from standard dimensions, e.g. 60 cm, 65 cm, 70 cm, 75 cm, 80 cm, 85 cm, 90 cm, 95 cm, 100 cm, 105 cm, 110 cm, 115 cm, 120 cm, 125 cm, 130 cm, etc.

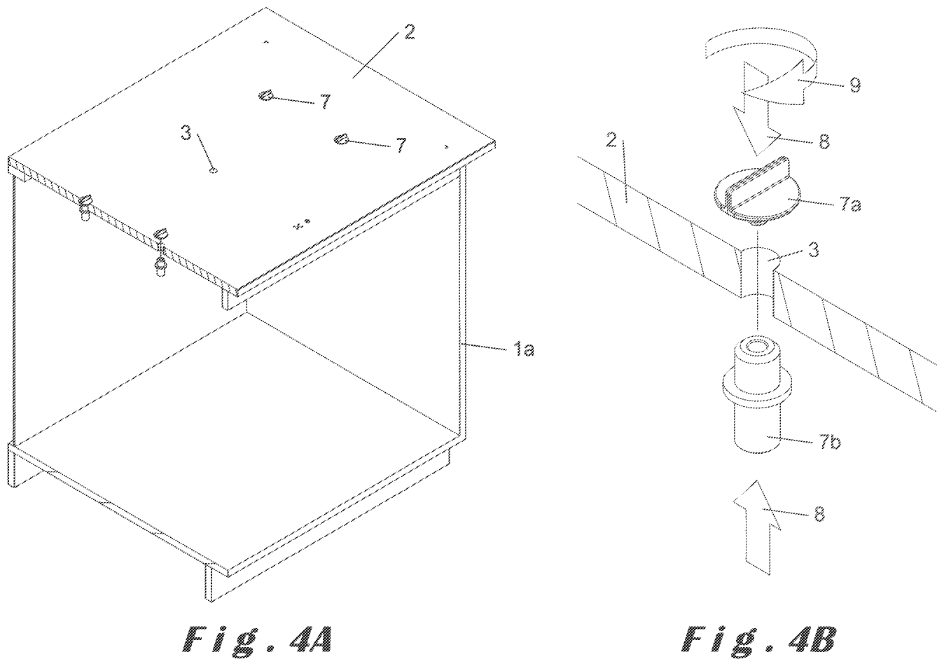

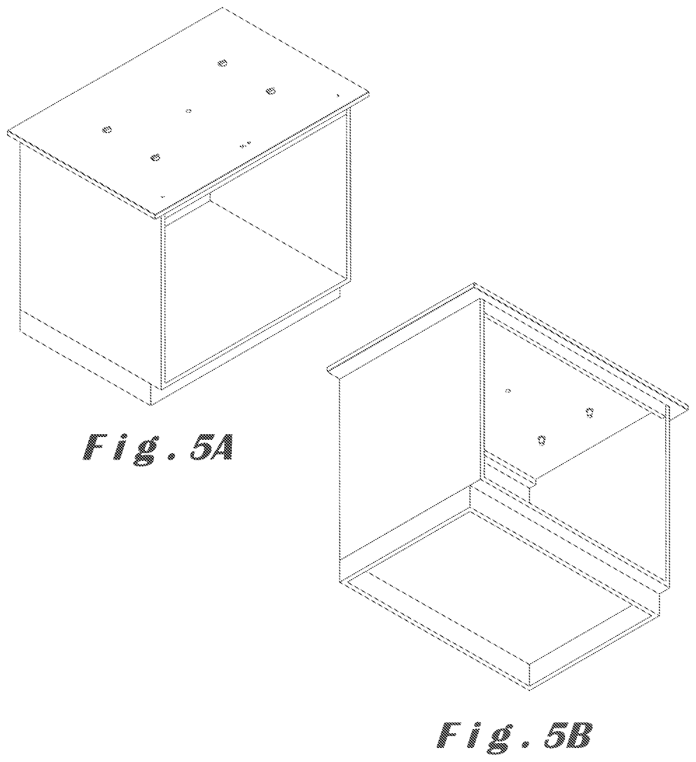

FIGS. 4A and 4B illustrate the placement of temporary securing members 7 through the openings 3. In the embodiment shown, each temporary securing member 7 comprises an upper part 7a and a lower part 7b which, as shown by the arrows 8, are pushed together through either side of the worktop 2 and secured to each other via rotation (see arrow 9). Each temporary securing member 7 comprises a magnetic element (not shown), e.g. a permanent magnet, which is typically provided in the lower part 7b. The placed temporary securing members 7 are shown in FIGS. 5A and 5B.

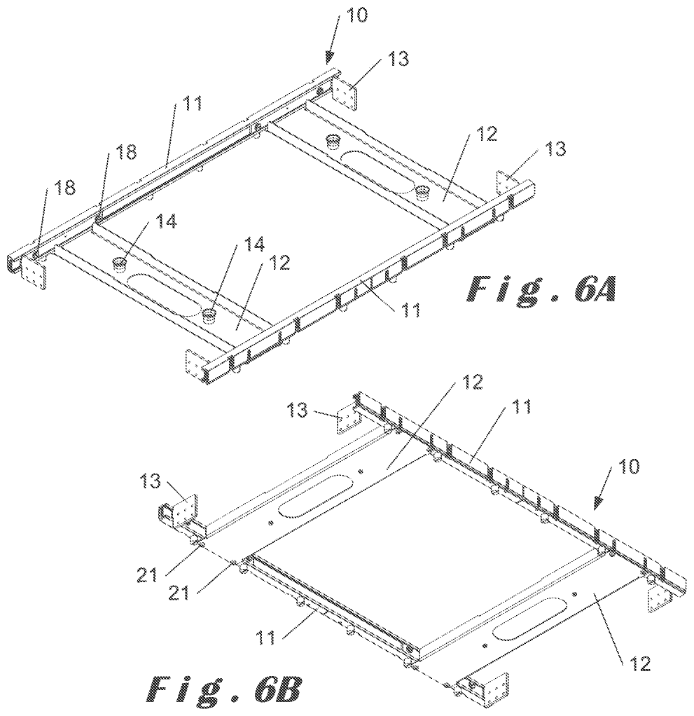

FIGS. 6A and 6B show different views of a support frame 10. The support frame 10 comprises two parallel rails 11 connected via one or more (two in the embodiment shown) transverse elements 12. A sliding L-shaped element 13 is provided near each end of the rails 11. One or more (two in the embodiment shown) cylindrical placement elements 14 are provided on each transverse element 12. A magnetic element (not shown), e.g. a permanent magnet, is arranged in these cylindrical placement elements 14. Near the cylindrical placement elements 14, the transverse element 12 is optionally made entirely or locally of a magnet-attracted material (e.g. iron).

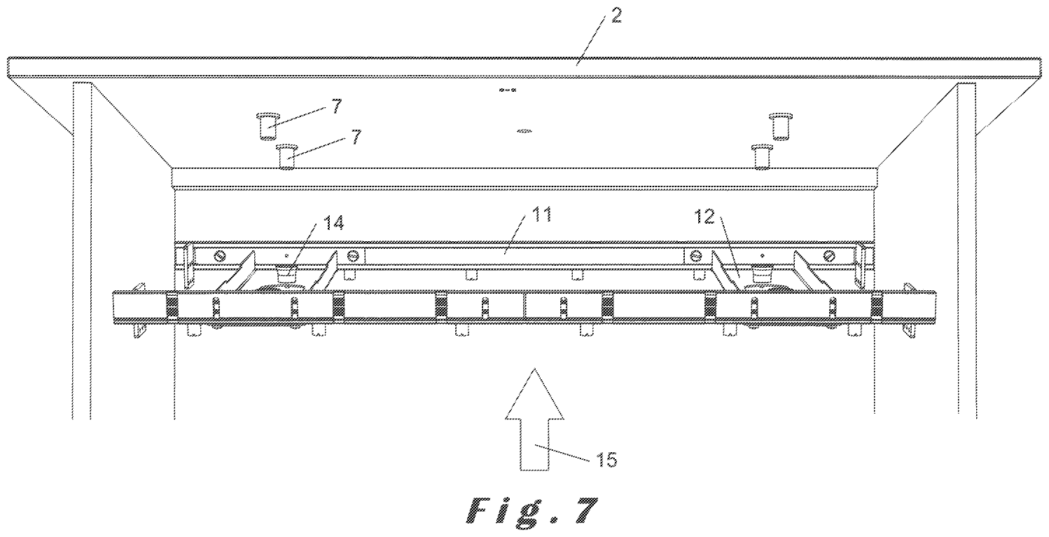

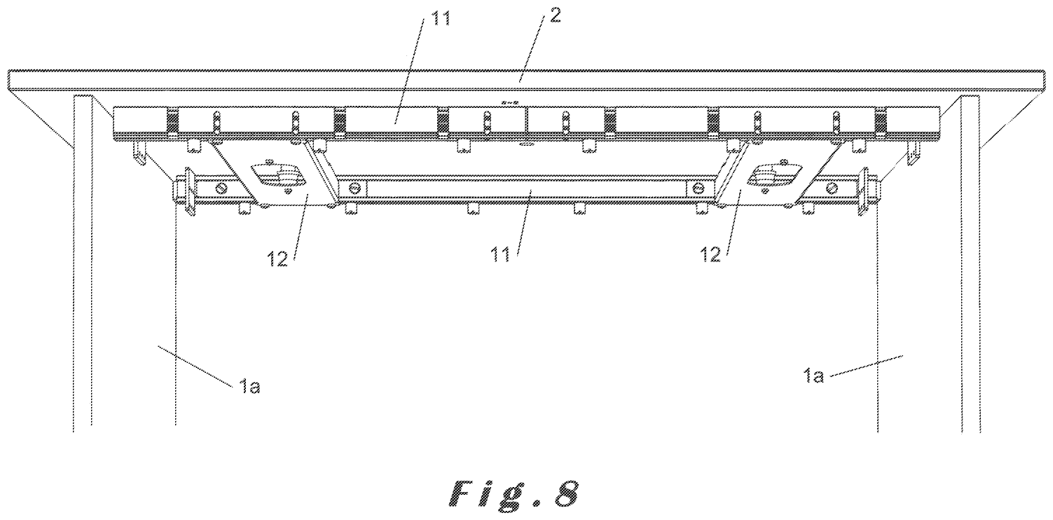

To place the support frame 10 in the cabinet space 1, first, if necessary, the rails 11 are shortened (possibly at both ends and preferably by about the same amount at opposite ends) to fit between the side walls 1a. Then the support frame 10 is slid up (see arrow 15 in FIG. 7) towards the worktop 2. Once close enough, there is magnetic attraction between the temporary securing members 7 and the cylindrical placement elements 14 to thus suspend the entire support frame 10 against the worktop 2 as shown in FIG. 8. Of course, temporary securing can also be carried out by using mechanical means to connect a transverse element to a temporary securing member.

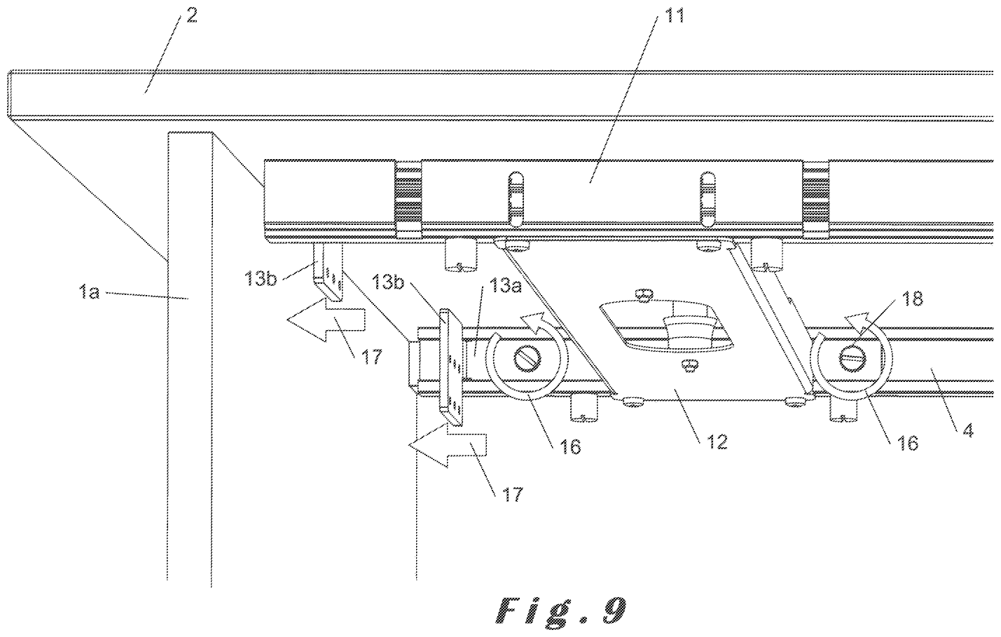

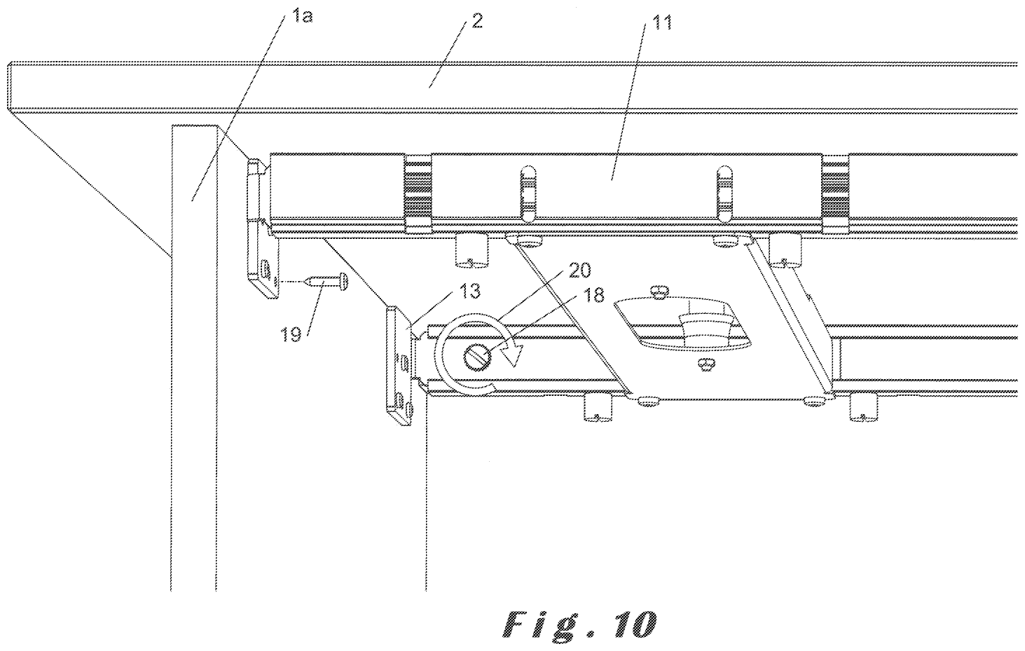

Next (as shown in FIGS. 9 and 10), the rails 11 are fixed to the side walls 1a. In the design shown, L-shaped parts 13 sliding in rails 11 are used for this purpose. These have a first leg 13a placed in the rail 11 and fixed thereon by the customary means (such as bolts 18). By loosening these bolts 18 (e.g. via rotation according to arrow 16), each L-shaped part 13 can be slid relative to the rail 11 so that the second leg 13b can be slid up to the side wall 1a (i.e. a slide in the direction indicated by arrow 17). By conventional means 19 (e.g. nails, tacks, screws, etc.), the second legs 13b are fastened to the side walls 1a, after which the bolts 18 are tightened again (e.g. via rotation according to arrow 20).

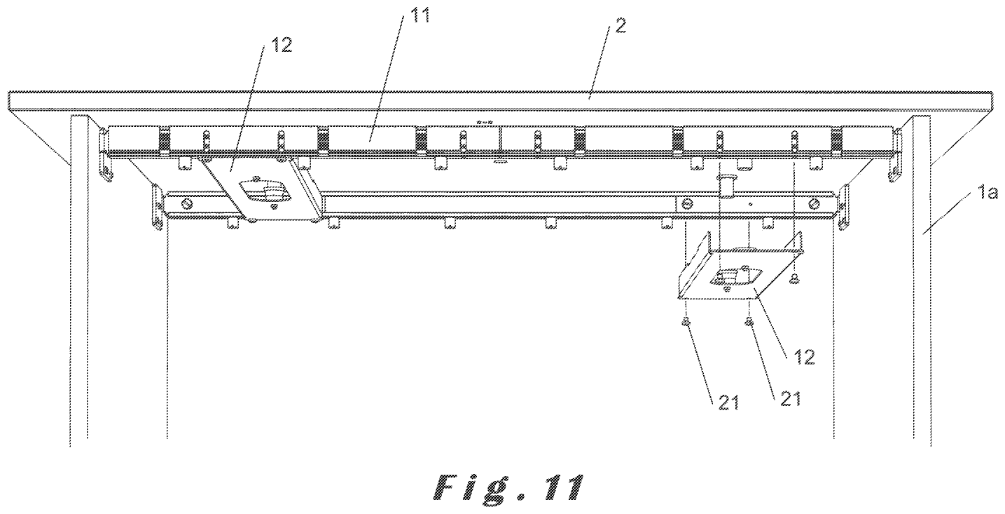

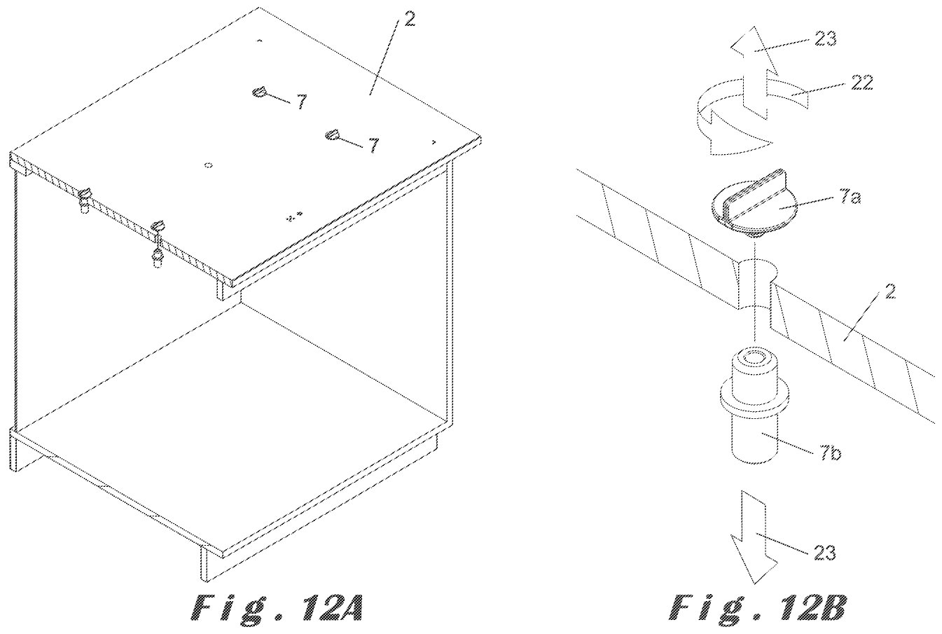

After the rails 11 are fastened to the side walls 1a (or more generally relative to the worktop 2), bolts 21 (or other conventional securing means) are loosened to release the one or more transverse elements 12 from the rails 11 as shown in FIG. 11. After this, the temporary securing means 7 can also be removed as shown in FIGS. 12A and 12B. In the process, the upper element 7a is first unscrewed (e.g. via rotation indicated by arrow 22), after which the elements 7a, 7b are slid apart as indicated by arrows 23.

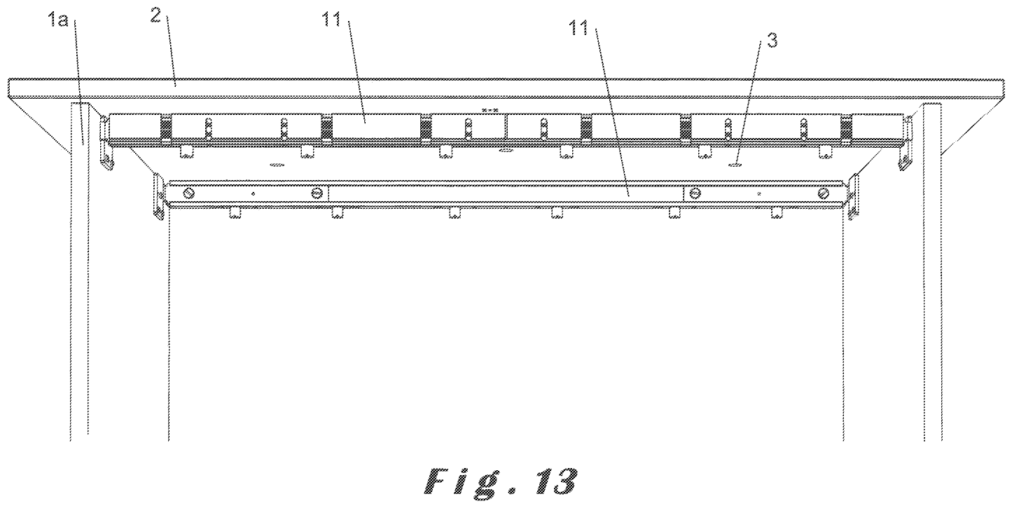

In this way, the condition shown in FIG. 13 is obtained, with a worktop 2 with two parallel rails 11 secured to the side walls 1a underneath with the openings 3 free again.

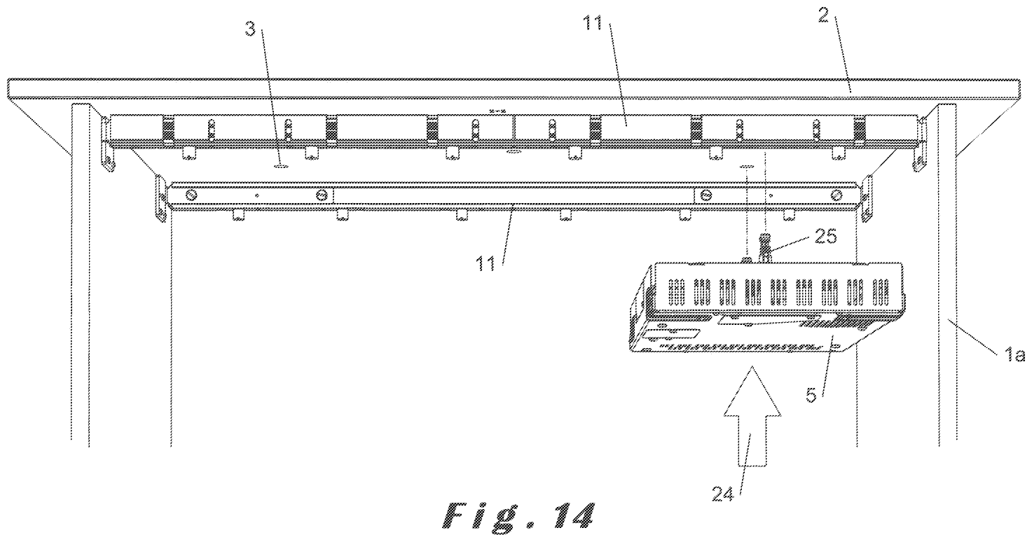

FIG. 14 shows the placement of the induction cooking device 5 under the worktop 2. To do this, the induction cooking device 5 is pushed up (see arrow 24) towards the worktop 2. Once close enough, magnetic attraction occurs between magnetic elements (not shown) in the induction cooking device 5 and magnetic elements (not shown) in the rails 11. For example, multiple permanent magnets are provided in the induction cooking device 5, wherein the rails 11 are provided with corresponding permanent magnets or, as in the design shown, are made of a magnet-attracted material (e.g. iron). In the process, tower-shaped elements 25 are placed on the upper surface of the induction cooking device 5 through the corresponding openings 3.

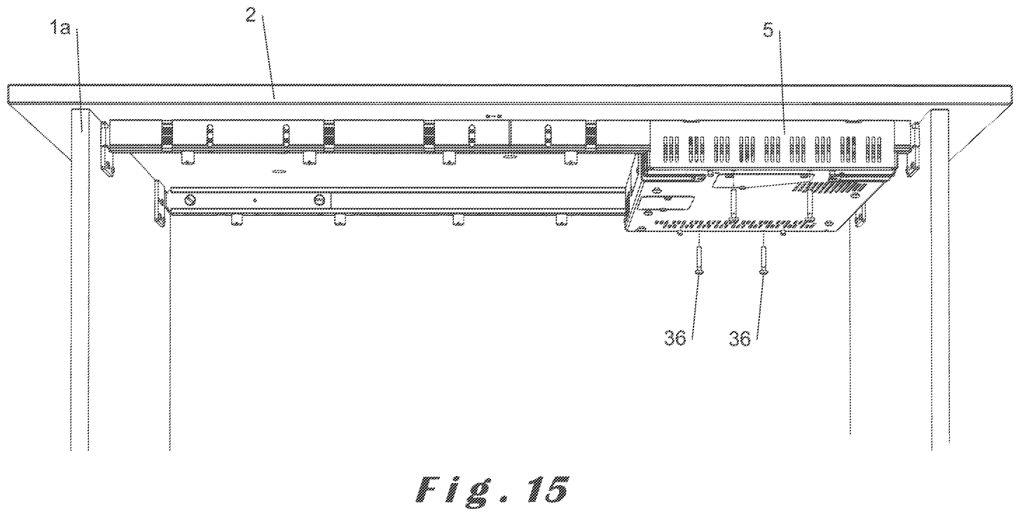

FIG. 15 illustrates the fastening of the induction cooking device 5 to the rails 11 by conventional securing means 36, e.g. bolts.

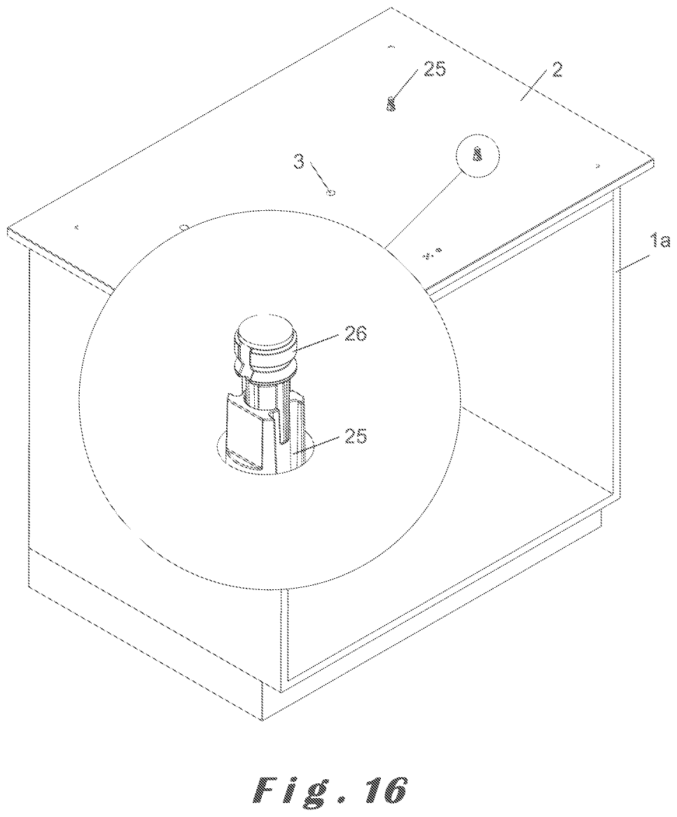

FIG. 16 illustrates the situation where one of the three induction cooking devices 5 is secured to the lower surface of the worktop 2, with the tower-shaped element 25 projecting from the upper surface of the worktop 2. A temperature sensor 26 is secured to this tower-shaped element 25 and is connected (e.g. via a wire 27) to a processor (not shown) that processes the temperature sensor measurements to determine the cooking pot temperature. The tower-shaped element 25 is a temporary solution to hold the temperature sensor 26 relative to the induction cooking device 5 during placement thereof to prevent the sensor 26 from being damaged and/or damaging other components.

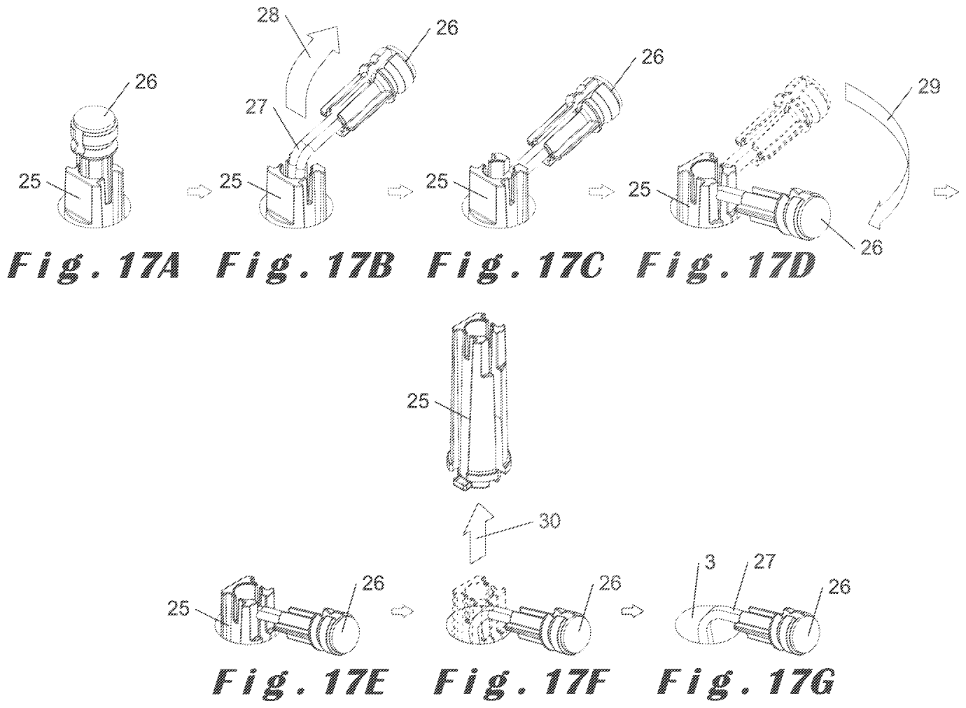

FIGS. 17A to 17G illustrate the possible steps for removing a tower-shaped element 25. FIG. 17A illustrates the initial situation after placement and fixing of the induction cooking device 5 under the worktop 2. FIG. 17B shows that the sensor 26 is detached from the tower-shaped element 25 by pulling it away diagonally upwards (illustrated via arrow 28). By placing the sensor 26 alongside the tower 25 with its cable 27 through part of the tower (FIG. 17C), it is possible to rotate the sensor 26 and the tower-shaped element 25 (illustrated using arrow 29 in FIG. 17D) and therefore detach the tower-shaped element 25 from the induction cooking device 5. This is the state shown in FIG. 17E, after which the tower-shaped element 25 can be removed by lifting it up (illustrated using arrow 30 in FIG. 17F). In this way, the situation shown in FIG. 17G is obtained, in which the temperature sensor 26 lies adjacent to the opening 3.

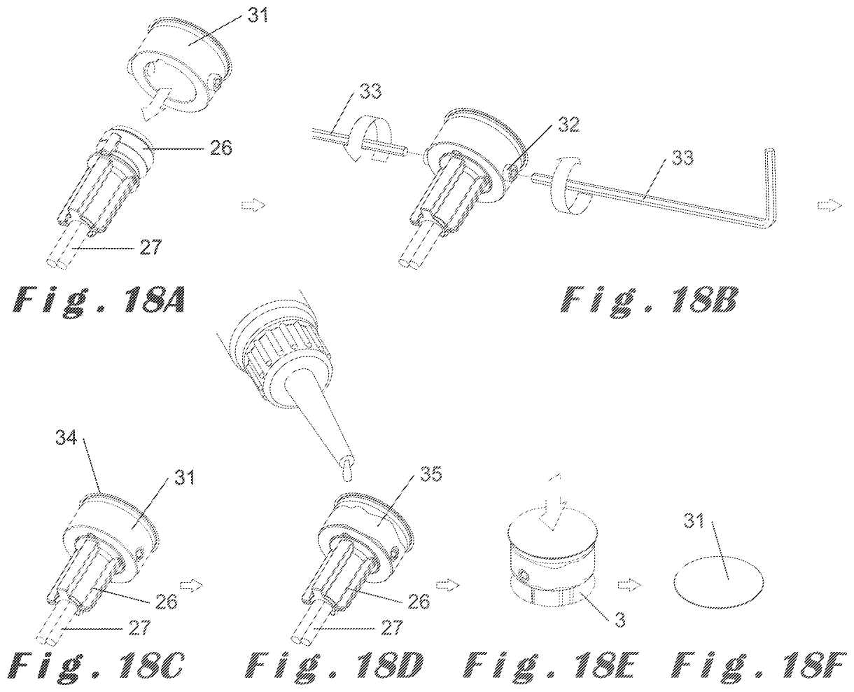

FIGS. 18A to 18F illustrate the completion of the temperature sensor 26 and its final placement. FIG. 18A shows the placement of a shield cover 31 on the upper surface of the temperature sensor 26. The shield cover 31 is secured to the temperature sensor 26 by conventional means 32 (such as set screws), optionally by using tools 33 provided for that purpose. In the design shown, the shield cover 31 comprises a flanged edge 34 whose advantages have already been described above. Glue or the like 35 can then be applied to the shield cover 31 (see FIG. 18D) so that the temperature sensor 26 together with the shield cover 31 can be placed in the opening 3 (see FIG. 18E) and firmly secured therein as shown in FIG. 18F.

By carrying out the method shown in FIGS. 3 to 18F as well as optionally carrying out a number of steps thereof more than once (e.g. placing multiple induction cooking devices on the same rails), the completed product shown in FIGS. 1 and 2 is obtained.

Although aspects of the disclosed invention were described with respect to specific embodiments, it is clear that these aspects can be carried out in other forms within the scope of the invention as defined by the claims.

1. A method for securing an induction cooking device under a worktop, which worktop has an upper surface and a lower surface facing each other and comprises at least one opening extending through the worktop between the upper surface and the lower surface, the method comprising:
providing a support frame comprising two mutually parallel rails connected via a transverse element;
providing the induction cooking device having an upper surface and a lower surface, wherein the upper surface of the induction cooking device is substantially flat and configured to be placed on the lower surface of the worktop and substantially parallel to the lower surface, which induction cooking device comprises a tower-shaped element projecting from the upper surface;
placing a temporary securing means in the opening in the worktop;
securing the transverse element to the temporary securing means for the purpose of securing the support frame to the lower surface of the worktop;
fixing said parallel rails relative to the worktop;
removing the transverse element and the temporary securing means;
placing the induction cooking device under the worktop with the tower-shaped element in the opening; and
fixing the induction cooking device to said parallel rails.

2. The method according to claim 1, wherein the worktop is supported by at least two walls facing each other and wherein fixing said parallel rails relative to the worktop comprises:
fixing the ends of each rail to one of said walls.

3. The method according to claim 2, wherein each rail of said rails is provided near its ends with an L-shaped securing member, wherein a first leg of each L-shaped securing member is slidably mounted on a corresponding rail, and wherein fixing the ends of each rail to one of said walls comprises:
sliding an L-shaped securing member along a corresponding rail until it rests against a corresponding wall; and
fixing a second leg of the L-shaped securing member against the corresponding wall by securing means such as bolts or screws.

4. The method according to claim 2, wherein the method further comprises:
shortening each rail depending on the shortest distance between said walls.

5. The method according to claim 1, wherein the temporary securing means comprises a magnetic element, wherein the transverse element comprises a magnetic element and wherein securing the transverse element to the temporary securing means comprises:
temporarily securing the support frame to the temporary securing means by means of magnetic attraction between the magnetic elements.

6. The method according to claim 1, wherein each of said rails is provided with a magnetic element, wherein the induction cooking device is provided with a magnetic element on opposite sides, and wherein fixing the induction cooking device to said parallel rails comprises:
temporarily securing the induction cooking device to said rails by means of magnetic attraction between the magnetic elements in said rails and the induction cooking device.

7. The method according to claim 6, wherein fixing the induction cooking device to said parallel rails comprises:
fastening the induction cooking device to said rails by means of securing means such as bolts or screws.

8. The method according to claim 1, wherein providing the induction cooking device comprises:
providing the induction cooking device with a tower-shaped element extending between a proximal end near the upper surface of the induction cooking device and a distal end, wherein a temperature sensor is provided near the distal end, which temperature sensor is connected to the induction cooking device via a cable; and
providing a shield cover.

9. The method according to claim 8, wherein, after fixing the induction cooking device to said parallel rails, the method further comprises:
detaching the temperature sensor from the tower-shaped element so that said temperature sensor is accessible on the upper surface of the worktop;
removing the tower-shaped element;
fixing the shield cover to the temperature sensor; and
fixing the shield cover in the opening, for example by gluing it therein.

10. The method according to claim 8, wherein providing a shield cover comprises:
providing a shield cover with a flanged edge.

11. The method according to claim 1, wherein placing a temporary securing means in the opening in the worktop comprises:
clamping the worktop between two separate elements which together form the temporary securing means.

12. The method according to claim 11, wherein clamping the worktop between two separate elements comprises:
placing a first element of the temporary securing means on the lower surface of the worktop; and
screwing thereon a second element of the temporary securing means to the upper surface of the worktop.

13. The method according to claim 1, wherein the worktop comprises N openings extending through the worktop between the upper surface and the lower surface, wherein N is a natural number greater than one, wherein the induction cooking device comprises N tower-shaped elements projecting from the upper surface and wherein the method comprises:
placing a temporary securing means in at least two of the N openings in the worktop;
securing the transverse element to at least two temporary securing means; and
placing the induction cooking device under the worktop with each tower-shaped element in a corresponding opening.

14. The method according to claim 1, wherein the method further comprises:
providing the worktop.

15. The method according to claim 14, wherein providing the worktop comprises:
providing a worktop having a substantially constant thickness, which thickness is at least 6 mm, in particular at least 12 mm, more specifically at least 16 mm, and even more specifically at least 18 mm, which thickness is at most 50 mm, in particular at most 40 mm, more specifically at most 30 mm, even more specifically at most 25 mm, and most specifically at most 22 mm, which thickness is most advantageously substantially 20 mm.
